(19) United States
(12) Patent Application Publication
(10) Pub. No.: US 2026/0219940 A1
(43) Pub. Date: Jul. 30, 2026

(54) SYSTEMS AND METHODS FOR GENERATING ONTOLOGICAL DATASETS FOR ENERGY DEVELOPMENT

(71) Applicant: Schlumberger Technology Corporation, Sugar Land, TX (US)

(72) Inventors: Cassandra WARREN, Aachen (DE); Andreas LAAKE, Aachen (DE); Britta EBERHARD, Aachen (DE); Nicole MASUREK, Aachen (DE); Charlotte WRAY, Aachen (DE); Victoire ROBLET-BAMBRIDGE, Abingdon (GB)

(21) Appl. No.: 19/146,935

(22) PCT Filed: Jan. 10, 2024
(86) PCT No.: PCT/US2024/011066

§ 371 Date: Jul. 10, 2025

Related U.S. Application Data
(60) Provisional application No. 63/479,315, filed on Jan. 10, 2023.
(60) Provisional application No. 63/490,875, filed on Mar. 17, 2023.

(51) Int. Cl. G06F 9/50

(52) U.S. Cl. CPC G06F 9/5027

(57) ABSTRACT

This disclosure is directed to methods and systems for generating ontological datasets using cloud data for energy development operations. According to one embodiment, a data processing engine stored in a memory device may receive cloud data from a plurality of sources and generate an ontology dataset based on parsing the cloud data. The data processing engine may initiate provisioning of an electronic dashboard on a display device based on a first user input. The electronic dashboard may include one or more display elements associated with the ontology dataset. Moreover, the one or more display elements of the electronic dashboard are activatable to load a computing resource associated with the cloud data. Furthermore, the one or more display elements of the electronic dashboard: are electronically linked to the computing resource; and may comprise picture data, video data, audio data, or textual data.

### CROSS-REFERENCE TO RELATED APPLICATIONS

This application claims priority to U.S. Provisional Patent Application No. 63/479,315, filed on Jan. 10, 2023, and titled “Cloud Native Knowledge Management,” and to U.S. Provisional Patent Application No. 63/490,875, filed on Mar. 17, 2023, and titled “Systems And Methods For Generating Ontological Datasets For Energy Development,” all of which are incorporated herein by reference in their entirety for all purposes.

### BACKGROUND

Development operations (e.g., research operations, exploration operations, and equipment configuration operations) associated with a resource (e.g., energy resource) require accurate, consistent, trusted, and auditable data and/or supporting materials (e.g., documentation) which often take a long time to aggregate and effectively use. In instances where the aforementioned operations require input from multiple domains, the necessary data that drives such development operations are often disparate and unintegrated which sometimes leads to development results that are not comparable and repeatable. A consequence of this is wasting of time, project resources, and needless repetition of tasks and operations thereby introducing inefficiencies into the development operations.

Moreover, the added challenge of scale and speed at which data and information are being generated and used for such development operations makes it difficult to effectively capture valuable insights from diverse sources or domains. Optimally reusing and recycling such vast amounts of available data to define “high probability” of success for energy projects is of importance to energy experts.

There is therefore a need for developing datasets that facilitate easy usage of interrelated data to optimize energy development operations.

### SUMMARY

This disclosure is directed to methods, systems, and computer programs for generating ontological datasets using cloud data for energy development operations. According to an embodiment, a method for generating ontological datasets using cloud data for energy development operations comprises: receiving cloud data from a plurality of sources; and generating an ontology dataset for the cloud data from the plurality of sources based on parsing the cloud data from the plurality of sources.

According to one embodiment, parsing the ontology dataset comprises: evaluating the cloud data to determine which analysis operations have been applied to the cloud data; confirming corresponding outputs generated based on the analysis operations executed on the cloud data; generating data categories for one or more of data elements of the cloud data or the outputs generated based on the analysis operations; and linking the data categories to generate the ontology dataset having an ontological structure. In one embodiment, the ontology data structure provides relationships between one or more of: the data elements of the cloud data; the outputs generated based on the analysis operations; or a combination of the data elements of the cloud data and the outputs generated based on the analysis operations.

The disclosed method also includes initiating provisioning of an electronic dashboard on a display device based on a first user input, wherein: the electronic dashboard includes one or more display elements associated with the ontology dataset; and the one or more display elements of the electronic dashboard are activatable to load a computing resource associated with the cloud data.

In other embodiments, a system and a computer program can include or execute the method described above. These and other implementations may each optionally include one or more of the following features.

In some implementations, the one or more display elements of the electronic dashboard are electronically linked to the computing resource such that activating the one or more display elements loads a visual indicator of the computing resource on a graphical user interface device associated with the cloud data.

In addition, the one or more display elements referenced above comprise at least one of: picture data associated with the ontology dataset; video data associated with the ontology dataset; audio data associated with the ontology dataset; and textual data including tabular or non-tabular data associated with the ontology dataset.

Moreover, the computing resource referenced above comprises one or more of: a file associated with the ontology dataset; an application associated the ontology dataset; configuration parameters of an electronic equipment associated with the ontology dataset; or configuration parameters of an electro-mechanical equipment associated with the ontology dataset.

Furthermore, the plurality of sources, according to one embodiment, includes one or more of: workflow data native to multiple domains associated with the cloud data; report data associated with energy development operations or energy exploration operations; report data associated with a resource site; report data associated with a site different from or similar to the resource site; or simulation data associated with the resource site, the site different from or similar to the resource site, the energy development operations, or the energy exploration operations.

In some embodiments, the multiple domains associated with the cloud data comprise one or more operations comprised in the energy development operations or the energy exploration operations.

In addition, the report data associated with the resource site includes data captured by one or more sensors disposed about the resource site including metadata associated with the data captured by the one or more sensors disposed at the resource site; and the simulation data associated with the resource site comprises analysis data associated with exploring a resource at the resource site including metadata associated with the analysis data.

Moreover, the workflow data native to the multiple domains associated with the cloud data includes metadata associated with the workflow data. The report data associated with the energy development operations or the energy exploration operations comprises metadata associated with the energy development operations or the energy exploration operations, according to some implementations.

Furthermore, the ontology dataset in conjunction with the electronic dashboard are configured, to: track operations data including workflow data native to multiple domains associated with the cloud data; and merge the operations data with one or more of: report data associated with a resource site, report data associated with energy development operations or energy exploration operations, report data associated with a site different from or similar to the resource site, or simulation data associated with the resource site, the site different from or similar to the resource site, or the energy development operations or the energy exploration operations. The electronic dashboard in conjunction with the ontology dataset may also be configured to: execute one or more opportunity assessment operations based on the merging; and generate, based on the one or more opportunity assessment operations, decisions data. The decisions data may indicate one or more of: a resource model associated with the resource site, the site different from or similar to the resource site, the energy development operations, or the energy exploration operations; and contextual data associated with: the energy development operations or the energy exploration operations, the resource site or the site different from or similar to the resource site, audit trail data that links one or more output data from the opportunity assessment operations with one or more data elements of the cloud data.

In some embodiments, the decisions data comprise data associated with opportunity assessment operations. The opportunity assessment operations includes one or more of: generating knowledge data indicating at least one relationship between: the data elements of the cloud data, the outputs generated based on the analysis operations, or a combination thereof; sequencing or structuring the knowledge data to generate at least an optimized set of computing operations associated with the energy development operations; and executing, using the optimized set of computing operations, one or more of: configuring an electronic or mechanical device associated with the energy development operations, or generating one or more computing models associated with the energy development operations.

The ontology dataset, according to one embodiment, comprises a library of data that connects information across multiple domains associated with the cloud data.

The ontological structure, in some embodiments, is based on a graph data structure, the graph data structure including: one or more nodes indicating at least one of the data elements of the cloud data or the outputs generated based on the analysis operations; and one or more vertices indicating at least one relationship between: the data elements of the cloud data, the outputs generated based on the analysis operations, or the data elements of the cloud data and the outputs generated based on the analysis operations.

The electronic dashboard, according to one embodiment, includes a search field for receiving the first user input or a second user input such that the one or more display elements are generated and displayed on the electronic dashboard based on the first user input or the second user input.

In some cases, the ontology dataset is updated based on configuration data from an entity that has access to the cloud data. The entity can comprise one of a user computing device or a computing device associated with an organization.

In one embodiment, the parsing operation discussed in association with the disclosed method comprises: determining source data indicating at least one source from which one or more data elements of the cloud data originated; and evaluating the cloud data to determine which analysis operations have been applied to the cloud data based on the source data.

In some embodiments, the disclosed method further comprises storing the ontology dataset into a database such that the database preserves the ontological structure of the ontology dataset.

### BRIEF DESCRIPTION OF THE DRAWINGS

The disclosure is illustrated by way of example, and not by way of limitation in the figures of the accompanying drawings in which like reference numerals are used to refer to similar elements. It is emphasized that various features may not be drawn to scale and the dimensions of various features may be arbitrarily increased or reduced for clarity of discussion.

FIG. 1 shows a high-level flowchart for generating ontological datasets for energy development operations, according to an embodiment.

FIG. 2 shows a cross-sectional view of a resource site for which the process of FIG. 1 may be executed, according to an embodiment.

FIG. 3 shows a networked system illustrating a communicative coupling of devices or systems associated with the resource site of FIG. 2, according to an embodiment.

FIG. 4A shows an exemplary electronic dashboard associated with an ontology dataset, according to some embodiments.

FIG. 4B shows an exemplary graph structure that links a plurality of similar and/or dissimilar raw data and/or Information data and/or knowledge data and/or decision data associated with a given ontology, according to some embodiments.

FIG. 5 shows an exemplary flowchart for generating an ontological dataset using cloud data for energy development operations, according to some embodiments.

FIG. 6 shows an exemplary flowchart for implementing the parsing operation discussed in association with FIG. 5, according to some embodiments.

### DETAILED DESCRIPTION

Reference will now be made in detail to embodiments, examples of which are illustrated in the accompanying drawings and figures. In the following detailed description, numerous specific details are set forth in order to provide a thorough understanding of the disclosed subject-matter. However, it will be apparent to one of ordinary skill in the art that this disclosure may be practiced without these specific details. In other instances, well-known methods, procedures, components, circuits, and networks have not been described in detail so as not to unnecessarily obscure aspects of the embodiments.

The disclosed systems and methods may be accomplished using interconnected devices and systems that obtain a plurality of data associated with various parameters of interest at a resource site. The workflows/flowcharts described in this disclosure, according to some embodiments, implicate a new processing approach (e.g., hardware, special purpose processors, and specially programmed general-purpose processors) because such analyses are too complex and cannot be done by a person in the time available or at all. Thus, the described systems and methods are directed to tangible implementations or solutions to specific technological problems in exploring/developing energy resources and/or exploring natural resources such as oil, gas, water, and other mineral resources.

Attention is now directed to methods, techniques, infrastructure, and workflows for operations provided in this disclosure. Some operations in the processing procedures, methods, techniques, and workflows disclosed herein may be combined while the order of some operations may be changed. Some embodiments include an iterative refinement of one or more data associated with the resource site or energy development operations via feedback loops executed by one or more computing device processors and/or through other control devices/mechanisms that make determinations regarding whether a given action, template, transformer model, or other resource data, is sufficiently accurate.

Exploration, development, and project decisions (e.g., energy development operations) in the energy sector can require consistent, trusted, and auditable technical and economic support material/data which often takes too long to generate, and/or aggregate, and/or interpret. In some cases, said technical and economic support data may be used to deliver results that are not comparable or reusable by multiple domains associated with energy development. In particular, valuable time is wasted in: trying to find adequate knowledge or expertise and/or other development data associated with energy development operations; or duplicating work associated with energy development operations. If users could easily or readily access, consume, and/or recycle technical or other energy development data digitally, such that said data includes direct links back to other raw similar or dissimilar data associated with energy development, considerable time and cost would be saved and results would not only be consistent but would also help support making optimal decision associated with energy development operations.

The disclosed solution provides a platform or an electronic dashboard that is configured or otherwise built upon a digital knowledgebase ontologically organized in a graph structure using defined ontologies that allow deep and efficient searching and usage of data associated with energy development. In particular, the disclosed systems leverage data relationships associated with various domains comprised in energy development operations to allow users to quickly and efficiently find appropriate information and other insights required for efficient energy development. For example, the various domains can comprise: an upstream domain related to exploring and/or developing energy; a midstream domain associated with the transportation and storage of energy; and a downstream domain related to refining and/or distributing energy.

According to one embodiment, the disclosed techniques break the cycle of challenges in finding the useful data, and/or results, and/or reports associated with energy development as well as challenges in repeating mistakes or executing inefficient operations associated with energy development. Specifically, the disclosed technology leverages data stored in a digital knowledge management library that can be used to ease access to appropriate data from a plurality of similar or dissimilar sources. In one embodiment, these sources include applications (e.g., third-party applications, non-third-party applications, etc.) configured to: capture (e.g., automatically capture) raw data (e.g., raw sensor data from a resource site), analysis data, or metadata associated with the raw data; digitally track workflows associated with energy development and/or collect analysis or insight data and/or metadata associated with said workflows. Digitally tracking said workflows, according to one embodiment, can enhance the audit trail process from energy development decisions back to the captured/raw data as well as link other underlying data associated with the energy development operations. This audit trail can form a foundation for informed or optimized energy development decisions.

According to one embodiment, the disclosed technology includes analytics features associated with the dashboard that can help use data associated with the dashboard more efficiently. The data associated with the dashboard may comprise knowledge graphs that analyze and reveal relationships between individual data items with attendant properties as well as suggest to a user, optimal combinations of data (analysis or interpretation data together with impacts of said data combinations) and thereby alter the way data transitions from the dashboard into effective and useful energy decisions. This beneficially lowers costs, reduces effort and time to complete processes, as well as minimizes process duplications and/or other inefficient energy development operations.

The scale and speed at which data and information are being generated makes it challenging for organizations and users to efficiently capture and access valuable insights from massive amounts of information from diverse sources associated with energy development. Rapid analysis of potential opportunities in new energy can be accelerated using the disclosed approach of data coordination via the disclosed electronic dashboard. Reusing and recycling all available data, information, and other energy domain knowledge beneficially reduces wasting effort spent on unsuccessful trials and thereby leads to a higher chance of success for potential energy development opportunities. In particular, the disclosed solution provides a new way of using energy related data powered by a cloud platform to help view and access data associated with energy development that is otherwise scattered across a plurality of different domains to drive the selection of the most valuable and/or useful knowledge data or information data for the user given the specific energy development objectives of said user.

To access data, some approaches of using key search lists, such as simple key word searching can limit the user to what they can extract; and the efficiency of the data extraction process. Moreover, data may be created due to the high demand of capturing information from all domains and/or other software associated which may require input data to generate complex and structured queries. In some cases, a user may leverage one or more dashboards that extract specific and/or tailored and/or customized knowledge data of interest. However, with increasing volumes of knowledge data, the user may spend longer times manually browsing through a plethora of material. Hence, a useful aspect of the disclosed solution is to provide an efficient way of accessing customized knowledge data and/or information data that is reliable, valid, consistent, and relevant to the energy development objectives of a user. In particular, this disclosure provides various implementations of a digital knowledge library together with attendant or associated ontologies.

### High-Level Flowchart

The disclosed data management and analytics system presents a technology that breaks the cycle of being unable to find useful data, results, and other resources (e.g., reports) which invariably leads to repeating mistakes and generating inefficient analyses associated with energy development operations. In particular, the disclosed technology covers the capture, storage, and integration of data using a data management application (e.g., a data processing engine) that eases access to data from various sources including public applications such as Web Feature Service (WFS) application and Web Map Service (WMS) application. In some embodiments, the disclosed technology relates to the capture, storage, and integration of data by a data processing engine using data from an application (e.g., DataIku application, Spotfire application) that is accessible through one or more application programming interfaces (APIs) or from proprietary applications such as Software Products including Petrel, Opportunity Assessor, GeoX, Techlog, and FDPlan. According to one embodiment, the data processing engine may receive and process data through automated collection of metadata associated with data from resource site(s), and may track and/or correlate energy workflow data with energy development operations. Furthermore, the disclosed technology can merge energy workflow data with reports and other literature to provide background/context for opportunity assessments operations. Moreover, the disclosed technology can create data models associated with energy development and/or model contextual results and/or workflows that allow energy-related data to be easily assimilated and reused. Digitally tracking such workflows automatically generates an audit trail from the contextual results back to the underlying data which is the foundation for informed and efficient energy development operations and decisions. Once processed data items are stored in, for example, a cloud computing storage, the stored data becomes available for further analytics and/or knowledge graphs as discussed below.

The following terms are contextually explained to clarify implementation details associated with exemplary embodiments in this disclosure:
Raw Data are uninterpreted data for example from field measurements, uninterpreted images or raw digitized text data. These are called raw data elsewhere herein. In some embodiments, raw data represents foundational units of Knowledge data and/or decision data. Without raw data (e.g., including but not limited to measurement data stored in the cloud, uninterpreted data stored in the cloud, operations data such as workflow data native to multiple domains, raw report data associated with energy development operations, report data associated with a resource site, statistic data and simulation data associated with one or more resource sites and/or from energy development operations), together with corresponding metadata, it is difficult to generate valid decisions data or data supporting decisions that are valid and are associated with a defined risk.
Information data can represent results from evaluating and/or interpreting the raw data. This can include processed/evaluated/interpreted raw data, images, models, output from databases and/or simulations created from the raw data as well as digital analysis of text data.
Knowledge data may include results data (simply called results) indicating assessments and interactions between multiple information data and or between information data and the raw data. In some cases, knowledge data includes data resulting from processing, evaluating, or interpreting information data and/or raw data in conjunction with relevant reference data that confirms (e.g., increases the accuracy or otherwise enhances) the results, thus creating a narrative that supports decision making. One challenge with knowledge data is to optimize the documentation of the results with background details as well as tracking the steps that lead to the narrative and subsequently back-tracing to the underlying raw data. This process is called audit trail elsewhere herein.
Decision data may comprise data associated with opportunity assessment operations as further discussed below.

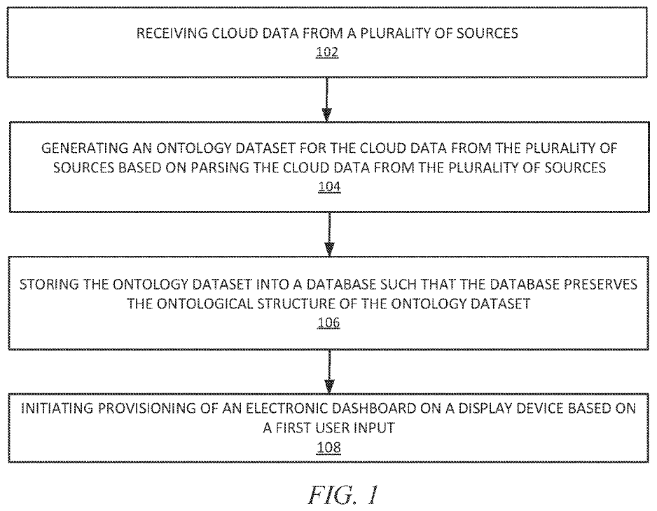

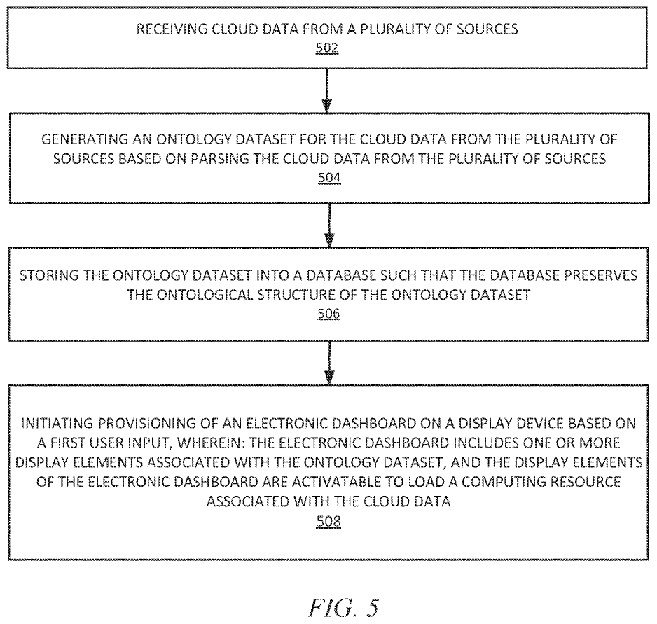

FIG. 1 shows a high-level flowchart for generating ontological datasets in computing networks for energy development operations. According to one embodiment, a data processing engine may receive, at block 102, cloud data from a plurality of sources. The data processing engine may parse, at block 104, the cloud data to generate an ontology dataset which can be stored at block 106 in a database that preserves an ontological structure of the ontology dataset. According to some embodiments, the data processing engine at block 108 may initiate provisioning of an electronic dashboard associated with the ontological dataset on a display device. These aspects are further discussed in the flowchart of FIG. 5.

### Resource Site

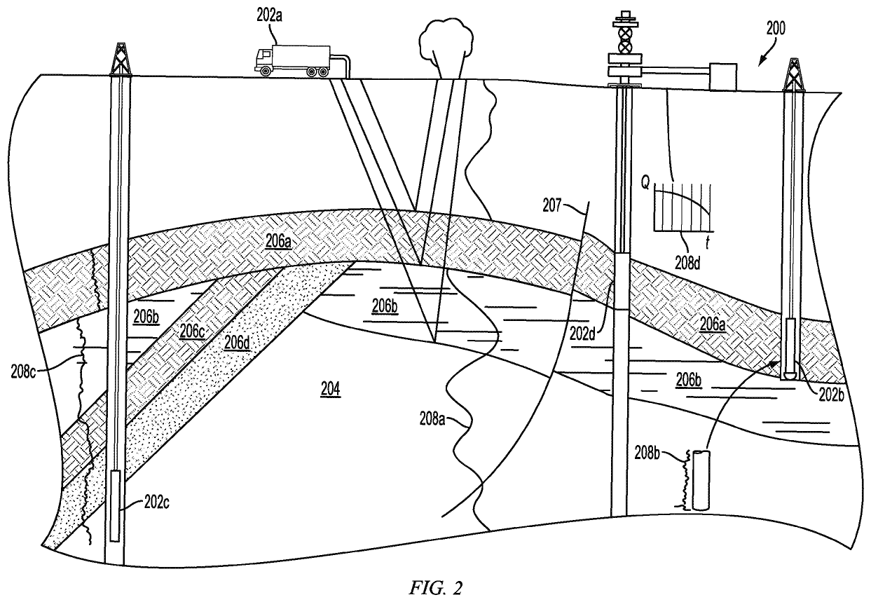

FIG. 2 shows a cross-sectional view of a resource site 200 for which the process of FIG. 1 may be executed. While the illustrated resource site 200 represents a subterranean formation, the resource site, according to some embodiments, may be below water bodies such as oceans, seas, lakes, ponds, wetlands, and rivers. In some cases, a model of a resource site or an energy development model may be used in lieu of a resource site.

According to one embodiment, various measurement tools capable of sensing one or more parameters such as seismic two-way travel time, density, resistivity, and production rate of a subterranean formation and/or geological formations may be provided at the resource site. As an example, wireline tools may be used to obtain measurement information related to geological attributes (e.g., geological attributes of a wellbore and/or reservoir) including geophysical and/or geochemical information associated with the resource site 200. In some embodiments, various sensors may be located at various locations around the resource site 200 to monitor and collect data for executing the process of FIG. 1.

Part, or all, of the resource site 200 may be on land, on water, or below water. In addition, while a resource site 200 is depicted, the technology described herein may be used with any combination of one or more resource sites (e.g., multiple oil fields and/or multiple wellsites), and/or one or more processing facilities. As can be seen in FIG. 2, the resource site 200 may have data acquisition tools 202a, 202b, 202c, and 202d positioned at various locations within the resource site 200. The subterranean structure 204 may have a plurality of geological formations 206a-206d. As shown, this structure may have several formations or layers, including a shale layer 206a, a carbonate layer 206b, a shale layer 206c, and a sand layer 206d. A fault 207 may extend through the shale layer 206a and the carbonate layer 206b. The data acquisition tools, for example, may be adapted to take measurements and detect geophysical and/or geochemical characteristics of the various formations shown.

While a specific subterranean formation with specific geological structures is depicted, it is appreciated that the resource site 200 may contain a variety of geological structures and/or formations, sometimes having extreme complexity. In some locations of a given geological structure, for example below a water line relative to the given geological structure, fluid may occupy pore spaces of the formations. Each of the measurement devices (e.g., sensors) may be used to measure properties of the formations and/or other geological features. While each data acquisition tool is shown as being in specific locations in FIG. 2, it is appreciated that one or more types of measurement may be taken at one or more locations across one or more sources of the resource site 200 or other locations for comparison and/or analysis. Data may also be acquired remotely. The data collected from various sources at the resource site 200 may be processed and/or evaluated and/or used as training data, and or used to generate high resolution result sets for characterizing a resource at the resource site, and/or used for generating resource models.

In one embodiment, the data collected by one or more sensors at the resource site may include data associated with the number of wells of a first reservoir or second reservoir at the resource site, data associated with the number of grid cells of the first or second reservoir, data associated with the average permeability of the first or second reservoir, data associated with the production history (e.g., number of years of production, amount of fluids produced etc.) of the first reservoir and/or a second reservoir. According to some embodiments, the number of wells of the first or second reservoir at the resource site may include one or more injectors (e.g., wells into which fluid including water is pumped) and/or one or more producers (e.g., wells from which fluid including hydrocarbons are extracted).

Data acquisition tool 202a is illustrated as a measurement truck, which may comprise devices or sensors that take measurements (e.g., raw data) of the subsurface through sound vibrations such as, but not limited to, seismic measurements. Drilling tool 202b may include a downhole sensor adapted to perform logging while drilling (LWD) data collection. Wireline tool 202c may include a downhole sensor deployed in a wellbore or borehole. Production tool 202d may be deployed from a production unit or Christmas tree into a completed wellbore. Examples of parameters that may be measured include weight on bit, torque on bit, subterranean pressures (e.g., underground fluid pressure), temperatures, flow rates, compositions, rotary speed, particle count, voltages, currents, gamma ray data associated with the well at the resource site, resistivity data associated with the well at the resource site, density, or porosity data associated with the well at the resource site, water saturation data associated with the well at the resource site, hydrocarbon saturation associated with the well at the resource site and/or other parameters associated with operations at the resource site.

Sensors may be positioned about the resource site 200 to collect data (e.g., raw data) relating to various oil field operations, such as sensors deployed by the data acquisition tools 202. The sensors may include any type of sensor such as a metrology sensor (e.g., temperature, humidity), an automation enabling sensor, an operational sensor (e.g., pressure sensor, H₂S sensor, thermometer, depth, tension), evaluation sensors, that can be used for acquiring data regarding the geological formation, wellbore information, formation fluid/gas information, wellbore fluid information, and data associated with gas/oil/water comprised in the formation/wellbore fluid. For example, the sensors may include accelerometers, flow rate sensors, pressure transducers, electromagnetic sensors, acoustic sensors, temperature sensors, chemical agent detection sensors, nuclear sensor, and/or any additional suitable sensors. In one embodiment, the data captured by the one or more sensors may be used to characterize, or otherwise generate one or more parameter values for a high-resolution result set used to, for example, generate and/or configure a resource model and/or a transformer model and/or a forecasting model. In other embodiments, test data or synthetic data may also be used in developing and/or configuring the resource model and/or the transformer model and/or the forecasting model via one or more simulations and or testing operations.

Evaluation sensors may be featured in downhole tools such as tools 202b-202d and may include for instance electromagnetic, acoustic, nuclear, and optic sensors. Examples of tools including evaluation sensors that can be used in the framework of the current method include electromagnetic tools including imaging sensors such as FMI™ or QuantaGeo™ (mark of Schlumberger); induction sensors such as Rt Scanner™ (mark of Schlumberger), multifrequency dielectric dispersion sensor such as (mark of Schlumberger); acoustic tools including sonic sensors, such as Sonic Scanner™ (mark of Schlumberger) or ultrasonic sensors, such as pulse-echo sensor as in UBI™ or PowerEcho™ (marks of Schlumberger) or flexural sensors PowerFlex™ (mark of Schlumberger); nuclear sensors such as Litho Scanner™ (mark of Schlumberger) or nuclear magnetic resonance sensors; fluid sampling tools including fluid analysis sensors such as InSitu Fluid Analyzer™ (mark of Schlumberger); distributed sensors including fiber optic. Such evaluation sensors may be used in particular for evaluating the formation in which the well is formed (i.e., determining petrophysical or geological properties of the formation), for verifying the integrity of the well (such as casing or cement properties) and/or analyzing the produced fluid (flow rate data and type of fluid data).

As shown, data acquisition tools 202a-202d may generate data plots or measurements 208a-208d, respectively. These data plots are depicted within the resource site 200 to demonstrate that data generated by some of the operations executed at the resource site 200.

Data plots 208a-208c are examples of static data plots that may be generated by data acquisition tools 202a-202c, respectively. However, it is herein contemplated that data plots 208a-208c may also be data plots that may be generated and updated in real time. These measurements may be analyzed to better define properties of the formation(s) and/or determine the accuracy of the measurements and/or check for and compensate for measurement errors. The plots of each of the respective measurements may be aligned and/or scaled for comparison and verification purposes. In some embodiments, base data (e.g., raw data) associated with the plots may be incorporated into site planning, modeling a test at the resource site 200 to generate, for example, information data and/or knowledge data. The respective measurements that can be taken may be any of the above. It is appreciated that the plots 201a-208c can be generated and/or stored digitally and may be replicated or otherwise printed to multiple file formats and/or printed on paper as the case may require.

Other data may also be collected, such as historical data of the resource site 200 and/or sites similar to the resource site 200, user inputs, information (e.g., economic information) associated with the resource site 200 and/or sites similar to the resource site 200, and/or other measurement data and other parameters of interest. Similar measurements may also be used to measure changes in formation aspects over time.

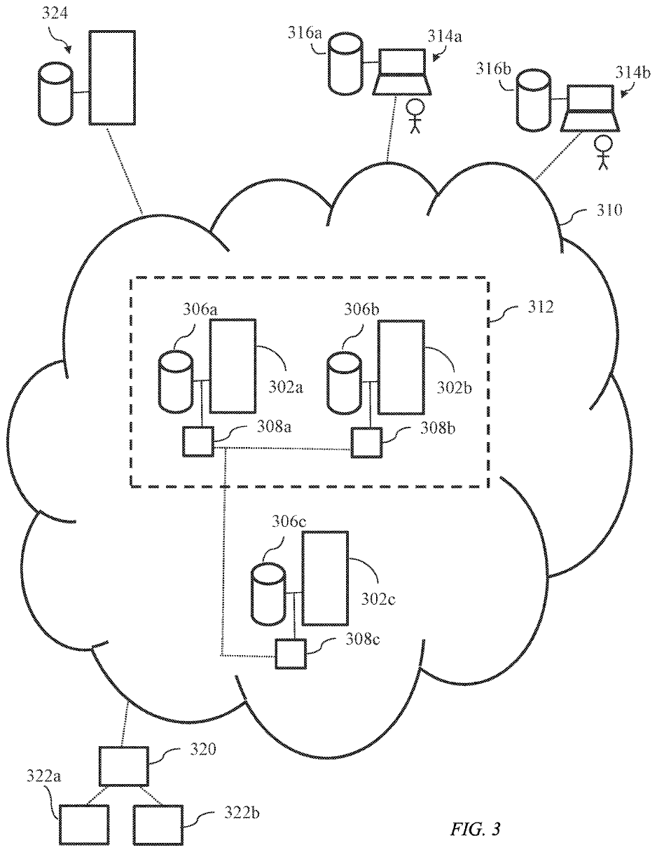

Computer facilities such as those discussed in association with FIG. 3 may be positioned at various locations about the resource site 200 (e.g., a surface unit) and/or at remote locations. A surface unit (e.g., one or more terminals 320) may be used to communicate with the onsite tools and/or offsite operations, as well as with other surface or downhole sensors. The surface unit may be capable of sending commands to the oil field equipment/systems, and receiving data therefrom. The surface unit may also collect data generated during production operations and can produce output data, which may be stored or transmitted for further processing.

The data collected by sensors may be used alone or in combination with other data. The data may be collected in one or more databases and/or transmitted on or offsite. The data may be historical data, real time data, or combinations thereof. The real time data may be used in real time, or stored for later use. The data may also be combined with historical data or other inputs for further analysis or for modeling purposes to optimize production processes at the resource site 200. In one embodiment, the data is stored in separate databases, or combined into a single database. It is appreciated that the term optimize/optimal and its variants (e.g., efficient or optimally) may simply indicate improving, rather than the ultimate form of ‘perfection’ or the like.

### High-Level Networked System

FIG. 3 shows a high-level networked system illustrating a communicative coupling of devices or systems associated with the resource site 200 of FIG. 2. The system shown in the figure may include a set of processors 302a, 302b, and 302c for executing one or more processes discussed herein. The set of processors 302 may be electrically coupled to one or more servers (e.g., computing systems) including memory 306a, 306b, and 306c that may store for example, program data, databases, and other forms of data. Each server of the one or more servers may also include one or more communication devices 308a, 308b, and 308c. The set of servers may provide a cloud-computing platform 310. In one embodiment, the set of servers includes different computing devices that are situated in different locations and may be scalable based on the needs and workflows associated with the resource site 200 of FIG. 2. The communication devices of each server may enable the servers to communicate with each other through a local or global network such as an Internet network. In some embodiments, the servers may be arranged as a town 312, which may provide a private or local cloud service for users. A town may be advantageous in remote locations with poor connectivity. Additionally, a town may be beneficial in scenarios with large networks where security may be of concern. A town in such large network embodiments can facilitate implementation of a private network within such large networks. The town may interface with other towns or a larger cloud network, which may also communicate over public communication links. Note that cloud-computing platform 310 may include a private network and/or portions of public networks. In some cases, a cloud-computing platform 310 may include remote storage and/or other application processing capabilities.

The system of FIG. 3 may also include one or more user terminals 314a and 314b each including at least a processor to execute programs, a memory (e.g., 316a and 316b) for storing data, a communication device and one or more user interfaces and devices that enable the user to receive, view, and transmit information. In one embodiment, the user terminals 314a and 314b is a computing system having interfaces and devices including keyboards, touchscreens, display screens, speakers, microphones, a mouse, and/or styluses. The user terminals 314 may be coupled to the one or more servers of the cloud-computing platform 310. The user terminals 314 may be client terminals or expert terminals, enabling collaboration between clients and experts through the system of FIG. 3.

The system of FIG. 3 may be associated with at least one or more resource sites 200 of FIG. 2 having, for example, a set of terminals 320, each including at least a processor, a memory, and a communication device for communicating with other devices coupled to the cloud-computing platform 310. The resource site 200 of FIG. 2 may also have one or more sensors (e.g., one or more sensors described in association with FIG. 2) or sensor interfaces 322a and 322b coupled to the set of terminals 320 and/or directly coupled to the cloud-computing platform 310. In some embodiments, data collected by the one or more sensors/sensor interfaces 322a and 322b may be processed to generate a one or more resource models (e.g., reservoir models) and/or one or more forecasting models and/or one or more resolved datasets used to generate the resource model and/or forecasting model which may be displayed on a user interface associated with the set of terminals 320, and/or displayed on user interfaces associated with the set of servers of the cloud computing platform 310, and/or displayed on user interfaces of the user terminals 314. Furthermore, various equipment/devices discussed in association with the resource site 200 of FIG. 2 may also be coupled to the set of terminals 320 and or coupled directly to the cloud-computing platform 310. The equipment and sensors may also include one or more communication device(s) that may communicate with the set of terminals 320 to receive orders/instructions locally and/or remotely from the resource site 200 of FIG. 2 and also send statuses/updates to other terminals such as the user terminals 314.

The system of FIG. 3 may also include one or more client servers 324 including a processor, memory, and communication device. For communication purposes, the client servers 324 may be coupled to the cloud-computing platform 310, and/or to the user terminals 314a and 314b, and/or to the set of terminals 320 at the resource site 200 of FIG. 2 and/or to sensors at the oil field, and/or to other equipment at the resource site 200 of FIG. 2.

A processor, as discussed with reference to the system of FIG. 3, may include a microprocessor, a graphical processing unit (GPU), a microcontroller, a processor module or subsystem, a programmable integrated circuit, a programmable gate array, or another control or computing device. According to some implementations, the system of FIG. 3 may comprise a cloud or a non-cloud virtual computing system that can implement one or more processes provided in this disclosure.

The memory/storage media discussed above in association with FIG. 3 can be implemented as one or more computer-readable or machine-readable storage media that are non-transitory. In some embodiments, storage media may be distributed within and/or across multiple internal and/or external enclosures of a computing system and/or additional computing systems. Storage media may include one or more different forms of memory including semiconductor memory devices such as dynamic or static random access memories (DRAMs or SRAMs), erasable and programmable read-only memories (EPROMs), electrically erasable and programmable read-only memories (EEPROMs) and flash memories; magnetic disks such as fixed, floppy and removable disks; other magnetic media including tape; optical media such as compact disks (CDs) or digital video disks (DVDs), BluRays or any other type of optical media; or other types of storage devices. “Non-transitory” computer readable medium refers to the medium itself (i.e., tangible, not a signal) and not data storage persistency (e.g., RAM vs. ROM).

Note that instructions can be provided on one computer-readable or machine-readable storage medium, or alternatively, can be provided on multiple computer-readable or machine-readable storage media distributed in a large system having possibly plural nodes and/or non-transitory storage means. Such computer-readable or machine-readable storage medium or media is (are) considered to be part of an article (or article of manufacture). The storage medium or media can be located either in a computer system running the machine-readable instructions, or located at a remote site from which machine-readable instructions can be downloaded over a network for execution. In some implementations, the instructions can be remotely executed or otherwise downloaded by a computing device (e.g., a client system) coupled to a cloud system (e.g., a cloud server) configured to execute the processes outlined in this disclosure.

It is appreciated that the described system of FIG. 3 is an example that may have more or fewer components than shown, may combine additional components, and/or may have a different configuration or arrangement of the components. The various components shown may be implemented in hardware, software, or a combination of both, hardware and software, including one or more data processing engines or a data manager module and/or application specific integrated circuits.

Further, the steps in the flowchart described below may be implemented by running one or more functional modules in an information processing apparatus such as general-purpose processors or application specific chips, such as ASICs, FPGAs, PLDs, GPUs or other appropriate devices associated with the system of FIG. 3. For example, the flowchart of FIG. 1 as well as the flowchart below may be executed using a data processing engine stored in memory 306a, 306b, or 306c such that the data processing engine includes instructions that are executed by the one or more processors such as processors 302a, 302b, or 302c as the case may be. The various modules of FIG. 3, combinations of these modules, and/or their combination with general hardware are included within the scope of protection of the disclosure. While one or more computing processors (e.g., processors 302a, 302b, or 302c) may be described as executing steps associated with one or more of the flowcharts described in this disclosure, the one or more computing device processors may be associated with the cloud-based computing platform 310 and may be located at one location or distributed across multiple locations. In one embodiment, the one or more computing device processors may also be associated with other systems of FIG. 3 other than the cloud-computing platform 310.

In some embodiments, a computing system is provided that includes at least one processor, at least one memory, and one or more programs stored in the at least one memory, such that the programs comprise instructions, which when executed by the at least one processor, are configured to perform any method disclosed herein.

In some embodiments, a computer readable storage medium is provided, which has stored therein one or more programs, the one or more programs including instructions, which when executed by a processor, cause the processor to perform any method disclosed herein. In some embodiments, a computing system is provided that includes at least one processor, at least one memory, and one or more programs stored in the at least one memory for performing any method disclosed herein. In some embodiments, an information processing apparatus for use in a computing system is provided for performing any method disclosed herein.

### EMBODIMENTS

One aspect of generating the disclosed graph structure associated with the electronic dashboard is the creation of a data ontology, which allows a plurality of similar and/or dissimilar data to be connected to each other. In particular, the disclosed graph structure harmonizes and/or links together heterogenous data from both unstructured datasets (e.g., PDF reports etc.) and/or structured datasets (e.g., measured well logs or seismic data), to generate linked data or other resultant data which can be used to optimize energy development operations. In one embodiment, a data ontology comprises a set of data classes, data properties, and/or data constraints.

Furthermore, the disclosed techniques determines a particular domain and jointly constructs using, for example, data associated with a subject matter expert (e.g., cloud data associated with the subject-matter expert or input data from a subject-matter expert) to establish an ontology that defines one or more data entities together with data relationships associated with said one or more data entities. This process can be iterative with revisions and refinements being applied as needed to enrich or otherwise enhance the data ontology (e.g., simply referred to as ontology elsewhere herein).

According to some embodiments, the following stages may be implemented in the creation of a data ontology associated with the disclosed electronic dashboard: raw data is digitally transformed such that information data and/or knowledge data is generated in a digital library with direct links back to the raw data and/or other information used to create the knowledge/information data; ontology data is then created and continually enriched for the knowledge/information data based on a graph structure; and the graph structure is then used to construct a fully searchable and scalable library comprising the knowledge data.

To demonstrate how the scalable library is used, the following scenario is presented: a domain expert (e.g., geoscientist) or some other user may execute seismic interpretation operations on a 2-dimensional section located in a first geographic location. The domain expert may be working at an offshore site associated with the first geographic location and observing (e.g., using a computational tool including the disclosed electronic dashboard) stratigraphic data associated with the site in question. Related knowledge data/information data from literature and/or previous projects associated with, or linked to the site in question may be suggested, via the electronic dashboard, and sorted by configurable criteria for presentation to the domain expert. Links to the related information and/or raw data of the suggested knowledge data or information data may be provided (e.g., displayed) via the electronic dashboard and made accessible to the domain expert. The electronic dashboard may provide one or more suggestions of relevant data or other related knowledge data (e.g., knowledge data linked by the same ontology) or information data that may be helpful to the objectives of the domain expert. If additional connections are made, with or without inputs from the domain expert, said connections are linked to associated ontologies, stored, and reused by the domain expert in the future or used by other users in the future.

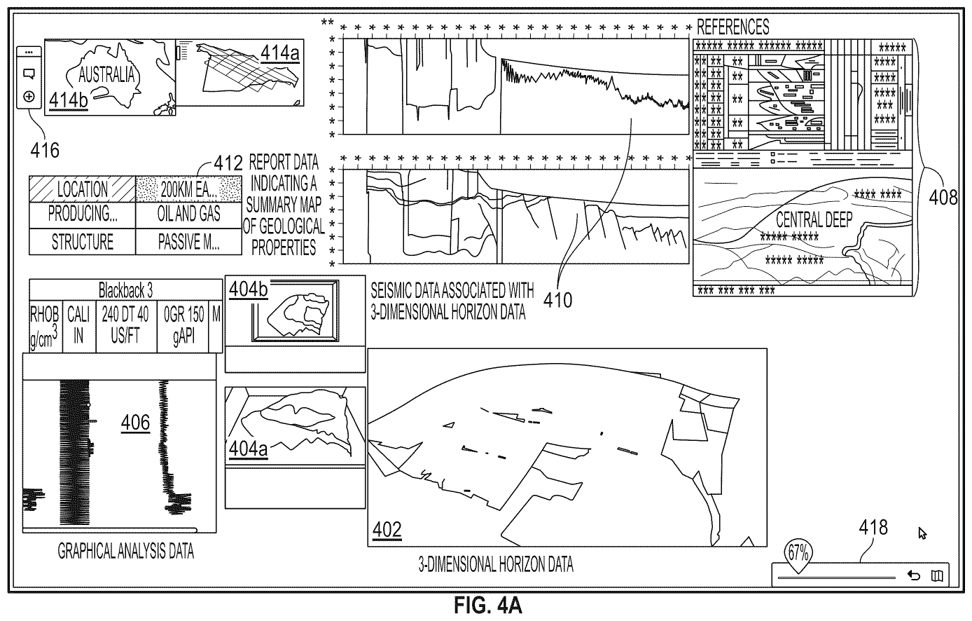

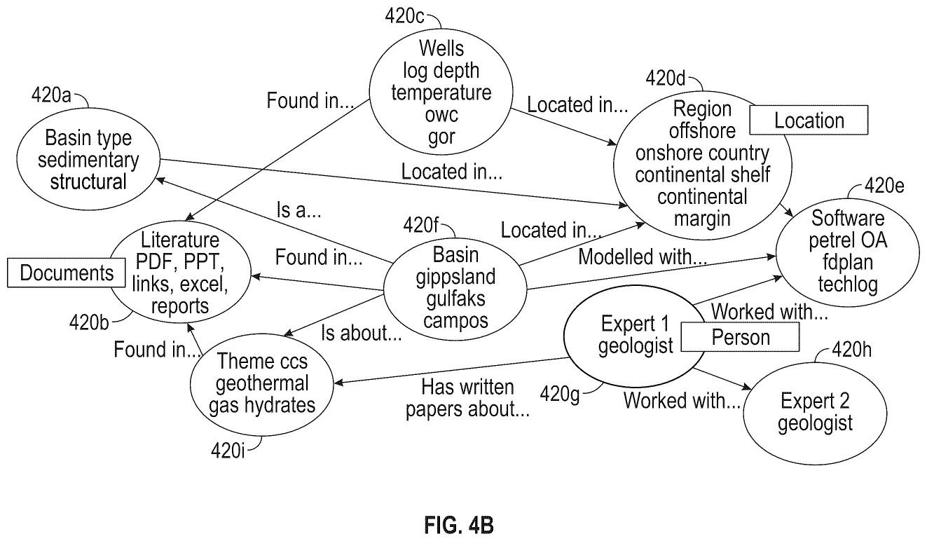

FIG. 4A shows an exemplary electronic dashboard associated with an ontology dataset, according to some embodiments. The electronic dashboard may include a plurality of interactive display elements indicating one or more knowledge data aggregated from analysis operations executed on cloud data. In some instances, the knowledge data can be directly linked to or traced back to the raw data or the cloud data. Furthermore, this tracing back or audit trail beneficially enables reuse of certain data elements within the cloud data that have already been analyzed or otherwise processed without the need to re-execute one or more analysis operations associated with said data elements. In one embodiment, reusing said data elements is based on relationships established between the various data elements of the cloud data based on structuring the data elements of the cloud data using an ontological structure as further discussed below in conjunction with FIG. 5.

According to one embodiment, the one or more display elements or interactive display elements of the electronic dashboard have a direct or indirect link to a computing resource such as a file, a report, a computing application, configuration parameters of an electronic equipment, or configuration parameters of an electro-mechanical equipment. It is appreciated that the interactive display elements of the electronic dashboard may include image data and/or textual data and/or tabular data, and/or document data or report data, etc. For example, the image data (e.g., raw data) may comprise a 3-dimensional image 402 with attendant knowledge data 404a and 404b that indicate specific properties of the 3-dimensional image data defined by a properties signature map as shown in FIG. 4A. In addition, the knowledge data 404a and/or 404b may have an associated analysis or information data 406 that provides granular insight or additional analysis information associated with the properties associated with the knowledge data 404a and 404b. In addition, one or more literature or other files and/or reports 408 associated with the raw data may also be displayed on the dashboard for easy access by the user. The files or reports, for example, may be in formats such as a Portable Document Format (PDF), Microsoft Word format, PowerPoint format, Excel format, Visio format, a Hypertext Markup Language (HTML) format, a Comma Separated Values (CSV) format, etc. It is appreciated that the files or reports may have associated links that are directly or indirectly tied to a computing resource. It is further appreciated that the files or reports may provide supplemental information data as the case may require.

In addition, multi-dimensional sensor data 410 associated with the raw data may also be provided on the disclosed electronic dashboard. According to one embodiment, the multi-dimensional data 410 includes data in multiple spatial domains that are, for example, recorded in a time-lapse manner. In some cases, the multi-dimensional sensor data 410 has a plurality of dimensions (e.g., multi-dimensional data having two or more dimensions or multi-dimensional spatial data having two or more dimensions, or multi-dimensional spatio-temporal data having two or more dimensions, or other 3-dimensional data) such that a value is generated (e.g., voxel value) to represent each data point comprised in the multi-dimensional data. That is to say for a given point in the multi-dimensional data having two or more dimensions, a single data value or magnitude is generated for said given point of the multi-dimensional data based on the multiple dimensional values of said given point of the multi-dimensional data. In one embodiment, the multi-dimensional data may be stored in a data cube. For example, multiple time-lapse multi-dimensional data (e.g., 3-dimensional seismic data) may be stored in the same data cube thereby adding 3-dimensions for each single value generated therefrom, for each of the data points of the time-lapse multi-dimensional data.

Moreover, tabular data 412 indicating parametric values associated with the raw data may also be displayed on the electronic dashboard. In one embodiment, report data 414a and 414b (e.g., information data) may be visualized on the electronic dashboard such that the report data indicates a summary geological map of a region or location associated with the raw data. In one embodiment, display element 416 may be used to: search specific knowledge data and/or information data associated with the raw data; annotate or add relevant contextual information to one or more of the elements displayed on the electronic dashboard; as well as update raw data, or knowledge data, or information data, etc., associated with the electronic dashboard. Moreover, toggle element 418 may be used to conduct interactive operations associated with the dashboard such as turning and/or moving around and/or zooming-into and/or zooming-out of one or more of the display elements of the electronic dashboard.

FIG. 4B shows an exemplary graph structure that links a plurality of similar and/or dissimilar raw data and/or Information data and/or knowledge data and/or decision data associated with a given ontology. In particular, the depicted implementation shows the linking or interconnection of a plurality of raw data (e.g., 420a, 420d, 420f, etc.) to a plurality of knowledge data and/or information data (e.g., 420b, 420c, 420e, 420g, 420h, and 420i) associated with a given energy development project. It is appreciated that the electronic dashboard may be referred to as a knowledge board due to the data relationships between the raw data and/or Information data and/or knowledge data and/or decision data, according to some embodiments.

### Detailed Flowcharts

FIG. 5 shows an exemplary flowchart for generating an ontological dataset using cloud data for energy development operations. It is appreciated that a data processing engine stored in a memory device may cause a computer processor to execute the various processing stages of FIG. 5. Furthermore, it is appreciated that operations outlined herein in association with the disclosed electronic dashboard may be used to augment or otherwise train or optimize one or more computing models associated with the electronic dashboard thereby enhancing the predictive aspects of the electronic dashboard as well as the data linkage properties between the raw data and the knowledge data and/or information data and/or decision data.

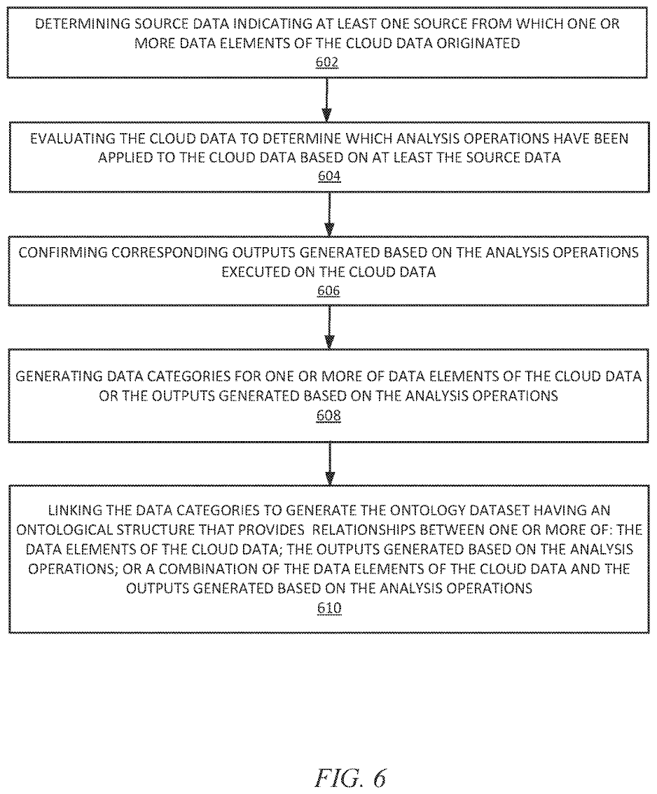

At block 502, the data processing engine may receive cloud data from a plurality of sources. According to one embodiment, the plurality of sources include: workflow data native to multiple domains associated with the cloud data; report data associated with energy development operations or energy exploration operations; report data associated with a resource site; report data associated with a site different from or similar to the resource site; or simulation data associated with the resource site, the site different from or similar to the resource site, or the energy development operations or the energy exploration operations. The data processing engine at block 504 may parse the cloud data from the plurality of sources to generate an ontology dataset for the cloud data. In other words, the data processing engine may generate the ontology dataset for the cloud data from the plurality of sources based on parsing the cloud data from the plurality of sources. These aspects are further discussed in association with FIG. 6.

At block 506, the data processing engine may store the ontology dataset in a database such that the database preserves an ontological structure of the ontology dataset. According to some implementations, the data processing engine initiates, at block 508, provisioning of an electronic dashboard (e.g., see electronic dashboard of FIG. 4A) on a display device based on a first user input. The electronic dashboard may include one or more display elements associated with the ontology dataset. Moreover, the one or more display elements of the electronic dashboard are activatable to load a computing resource associated with the cloud data. It is appreciated that the computing resource may facilitate optimally executing one or more computing operations and/or one or more energy development operations according to some embodiments. The one or more energy development operations or one or more computing operations may include generating computing models associated with the one or more energy development operations, generating configuration parameters for controlling equipment at a resource site (e.g., controlling a valve at the resource site, configuring pumps in real-time or near-real-time to adjust fluid injection or production rates at the resource site, and/or parameterizing sensors at the resource site.).

FIG. 6 provides an exemplary flowchart for implementing the parsing operation discussed in association with step 504 of FIG. 5, according to some embodiments. At block 602, the data processing engine determines source data indicating at least one source from which one or more data elements of the cloud data originated. The data processing engine may evaluate at block 604, the cloud data to determine which analysis operations have been applied to the cloud data based on at least the source data. According to some embodiments, evaluating the cloud data to determine which analysis operations have been applied to the cloud data may include assessing which applications were used to generate the cloud data and/or which domains are associated with said applications used to generate the cloud data. Furthermore, the data processing engine at block 606 may confirm corresponding outputs generated based on the analysis operations executed on the cloud data. In some embodiments, confirming corresponding outputs or results data generated based on the analysis operations executed on the cloud data may include executing one or more quality control operations on the results data including quantitatively verifying one or more values associated with the results data, correlating the results data with previously generated results data to determine anomalies associated with the results data, updating parameters associated with the analysis operations to determine data impacts on the results data. At block 606, the data processing engine may generate data categories for one or more of data elements of the cloud data or the outputs generated based on the analysis operations. The data processing engine at block 610 may link the data categories to generate the ontology dataset having an ontological structure. The ontological structure may provide relationships between one or more of: the data elements of the cloud data; the outputs generated based on the analysis operations; or a combination of the data elements of the cloud data and the outputs generated based on the analysis operations. In some implementations, the relationships may be based on relationships between the workflow data native to the multiple domains associated with the cloud data or the energy development operations. For example, relationships comprised in workflows associated with energy development operations for hydrocarbon exploration and production may include relationships between:
location data associated with a resource site and reservoir analysis operations data of the resource site or the site similar to or different from the resource site;
location data associated with the resource site and hydrocarbon drilling operations data at the resource site or the site similar to or different from the resource site;
location data associated with the resource site and hydrocarbon production operations data at the resource site or the site similar to or different from the resource site;
hydrocarbon drilling operations data and hydrocarbon production operations data at the resource site or the site similar to or different from the resource site; or
energy research data or energy literature data associated a document owner (e.g., an energy expert reviewing or applying the energy research data) relative to data from one or more domain experts (e.g., experts in reservoir analysis operations, experts in hydrocarbon drilling operations, or experts in hydrocarbon production operations).

These and other implementations may each optionally include one or more of the following features. The multiple domains associated with the cloud data may comprise one or more operations comprised in the energy development operations or the energy exploration operations. Furthermore, the ontology dataset in conjunction with the dashboard may be configured to: track operations data including the workflow data native to the multiple domains associated with the cloud data; merge the operations data with one or more of report data associated with the resource site, report data associated with the energy development operations or the energy exploration operations, report data associated with the site different from or similar to the resource site, or simulation data associated with the resource site, the site different from or similar to the resource site, or the energy development operations or the energy exploration operations. Furthermore, the ontology dataset in conjunction with the dashboard may be configured to execute one or more opportunity assessment operations based on the merging. In one embodiment, the electronic dashboard in conjunction with the ontology data set may be configured to generate, based on the one or more opportunity assessment operations, decisions data. The decisions data may comprise a resource model associated with the resource site, the site different from or similar to the resource site, the energy development operations, or the energy exploration operations. In some embodiments, the decisions data comprises contextual data associated with: the energy development operations or the energy exploration operations; the resource site or the site different from or similar to the resource site; or audit trail data that links one or more output data from the opportunity assessment operations with one or more data elements of the cloud data. In some cases, the contextual data includes research data, organization-specific data, or background information associated with the resource site, or the site different from or similar to the resource site, or the energy development operations, or the energy exploration operations. Furthermore, it is appreciated that the decisions data can comprise data indicating the opportunity assessment operations, according to some embodiments. The opportunity assessment operations may include generating knowledge data indicating at least one relationship between: the data elements of the cloud data, the outputs generated based on the analysis operations, or a combination thereof. The opportunity assessment operations may further include sequencing or structuring the knowledge data to generate at least an optimized set of computing operations associated with the energy development operations. In such cases the optimized set of computing operations may include using at least one display element comprised in the one or more display elements of the electronic dashboard to update or otherwise control a device, an equipment, or a model associated with at least the energy development operations. Moreover, the opportunity assessment operations may include executing, using the optimized set of computing operations, one or more of: configuring a parameter of an electronic or mechanical device associated with the energy development operations, and/or generating one or more computing models associated with the energy development operations as discussed in association with block 610 of FIG. 6. It is appreciated that the various processing stages of FIG. 6 may be iteratively executed based on reception of new cloud data and/or reception of updated cloud data associated with previously received cloud data to refine or otherwise enhance the ontology dataset and thereby improve the ontological structure discussed in association with block 610 of FIG. 6. In such cases, once the new or updated data is received, the workflow of FIG. 6 may be re-executed (e.g., iteratively executed) from block 602 to block 610. In some embodiments, iterating the various processing stages outlined in FIG. 6 may be based on the new cloud data and/or the updated cloud data and/or one or more anomalies or inaccuracies in the ontological dataset and/or previously established or newly established relationships between data elements of the ontological structure.

In some implementations, the computing resource comprises one or more of: a file associated with the ontology dataset; an application associated the ontology dataset; configuration parameters of an electronic equipment associated with the ontology dataset; or configuration parameters of an electro-mechanical equipment associated with the ontology dataset. Furthermore, the one or more display elements of the electronic dashboard are electronically linked to the computing resource such that activating the one or more display elements loads a visual indicator (e.g., an icon, or a link) of the computing resource on a graphical user interface device associated with the cloud data. According to some embodiments, the one or more display elements may be linked to the execution of one or more operations or tasks on or by the computing resource (e.g., a computing device, an electronic equipment, an electromechanical system, a system associated with energy exploration operations, etc.). In addition, the one or more display elements of the electronic dashboard may comprise at least one of: picture data associated with the ontology dataset; video data associated with the ontology dataset; audio data associated with the ontology dataset; and textual data including tabular or non-tabular data associated with the ontology dataset. Moreover, the ontology dataset comprises a library of data that connects information across the multiple domains associated with the cloud data. The ontological structure, in some implementation, is based on a graph data structure. The graph data structure may include one or more nodes indicating at least one of the data elements of the cloud data or the outputs generated based on the analysis operations. The ontological structure may also include one or more vertices indicating at least one relationship between: the data elements of the cloud data; the outputs generated based on the analysis operations; or the data elements of the cloud data and the outputs generated based on the analysis operations. Furthermore, the electronic dashboard may include a search field for receiving the first user input or a second user input such that the one or more display elements may be generated and displayed on the electronic dashboard based on the first user input or the second user input.

According to some implementations, the ontology dataset is updated based on configuration data from an entity that has access to the cloud data. The entity may comprise one of a user computing device or a computing device associated with an organization.

The report data associated with the resource site discussed in conjunction with FIG. 5 may include data captured by one or more sensors disposed about the resource site and can include metadata associated with the data captured by the one or more sensors disposed at the resource site. Similarly, the simulation data associated with the resource site discussed in conjunction with FIG. 5 may comprise analysis data associated with exploring a resource at the resource site including metadata associated with the analysis data. Moreover, the operations data including the workflow data native to the multiple domains associated with the cloud data may include metadata associated with the operations data. The report data associated with the energy development operations or the energy exploration operations may also include metadata associated with the energy development operations or the energy exploration operations.

While any discussion of or citation to related art in this disclosure may or may not include some prior art references, there is no concession or acquiescence to the position that any given reference is prior art or analogous prior art.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to explain the principles of the invention and its practical applications, to thereby enable others skilled in the art to use the invention and various embodiments with various modifications as are suited to the particular use contemplated.

It will also be understood that, although the terms first or second may be used herein to describe various elements, these elements should not be limited by these terms. These terms are used to distinguish one element from another. For example, a first object or step could be termed a second object or step, and, similarly, a second object or step could be termed a first object or step, without departing from the scope of the invention. The first object or step, and the second object or step, are both objects or steps, respectively, but they are not to be considered the same object or step.

The terminology used in the description herein is for the purpose of describing particular embodiments and is not intended to be limiting. As used in the description of the invention and the appended claims, the singular forms “a,” “an” and “the” are intended to include the plural forms as well, unless the context clearly indicates otherwise. It will also be understood that the term “and/or” as used herein refers to and encompasses any possible combination of one or more of the associated listed items. It will be further understood that the terms “includes,” “including,” “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” may be construed to mean “when” or “upon” or “in response to determining” or “in response to detecting,” depending on the context.

Those with skill in the art will appreciate that while some terms in this disclosure may refer to absolutes, the methods and techniques disclosed herein may also be performed on fewer than all of a given thing, e.g., performed on one or more components and/or performed by one or more computing device processors or one or more data processing engines. Accordingly, in instances in the disclosure where an absolute is used, the disclosure may also be interpreted to be referring to a subset.

What is claimed is:

1. A method for generating an ontological dataset using cloud data for development operations, the method comprising:
receiving cloud data from a plurality of sources;
generating an ontology dataset for the cloud data from the plurality of sources based on parsing the cloud data from the plurality of sources including:
evaluating the cloud data to determine which analysis operations have been applied to the cloud data;
confirming corresponding outputs generated based on the analysis operations executed on the cloud data;
generating data categories for one or more of data elements of the cloud data or the outputs generated based on the analysis operations; and
linking the data categories to generate the ontology dataset having an ontological structure that provides relationships between one or more of:
the data elements of the cloud data,
the outputs generated based on the analysis operations, or
a combination of the data elements of the cloud data and the outputs generated based on the analysis operations; and
initiating provisioning of an electronic dashboard on a display device based on a first user input, wherein:
the electronic dashboard includes one or more display elements associated with the ontology dataset, and
the one or more display elements of the electronic dashboard are activatable to load a computing resource associated with the cloud data.

2. The method of claim 1, wherein the one or more display elements of the electronic dashboard are electronically linked to the computing resource such that activating the one or more display elements loads a visual indicator of the computing resource on a graphical user interface device associated with the cloud data.

3. The method of claim 1, wherein the one or more display elements comprise at least one of:
picture data associated with the ontology dataset,
video data associated with the ontology dataset,
audio data associated with the ontology dataset, and
textual data including tabular or non-tabular data associated with the ontology dataset.

4. The method of claim 1, wherein the computing resource comprises one or more of:
a file associated with the ontology dataset,
an application associated the ontology dataset,
configuration parameters of an electronic equipment associated with the ontology dataset, or
configuration parameters of an electro-mechanical equipment associated with the ontology dataset.

5. The method of claim 1, wherein the plurality of sources includes one or more of:
workflow data native to multiple domains associated with the cloud data;
report data associated with energy development operations or energy exploration operations,
report data associated with a resource site,
report data associated with a site different from or similar to the resource site, or
simulation data associated with the resource site, the site different from or similar to the resource site, the energy development operations or the energy exploration operations.

6. The method of claim 5, wherein the multiple domains associated with the cloud data comprise one or more operations comprised in the energy development operations or the energy exploration operations.

7. The method of claim 5, wherein
the report data associated with the resource site includes data captured by one or more sensors disposed about the resource site including metadata associated with the data captured by the one or more sensors disposed at the resource site, and
the simulation data associated with the resource site comprises analysis data associated with exploring a resource at the resource site including metadata associated with the analysis data.

8. The method of claim 5, wherein
the workflow data native to the multiple domains associated with the cloud data includes metadata associated with the workflow data, and
the report data associated with the energy development operations or the energy exploration operations comprises metadata associated with the energy development operations or the energy exploration operations.

9. The method of claim 1, wherein the ontology dataset in conjunction with the electronic dashboard are configured, to:
track operations data including workflow data native to multiple domains associated with the cloud data;
merge the operations data with one or more of:
report data associated with a resource site,
report data associated with energy development operations or energy exploration operations,
report data associated with a site different from or similar to the resource site, or
simulation data associated with the resource site, the site different from or similar to the resource site, or the energy development operations or the energy exploration operations;
execute one or more opportunity assessment operations based on the merging;
generate, based on the one or more opportunity assessment operations, decisions data indicating one or more of:
a resource model associated with the resource site, the site different from or similar to the resource site, the energy development operations, or the energy exploration operations,
contextual data associated with:
the energy development operations or the energy exploration operations,
the resource site or the site different from or similar to the resource site,
audit trail data that links one or more output data from the opportunity assessment operations with one or more data elements of the cloud data.

10. The method of claim 9, wherein the decisions data comprise data associated with opportunity assessment operations, the opportunity assessment operations including one or more of:
generating knowledge data indicating at least one relationship between:
the data elements of the cloud data,
the outputs generated based on the analysis operations, or
a combination thereof;
sequencing or structuring the knowledge data to generate at least an optimized set of computing operations associated with the energy development operations;
executing, using the optimized set of computing operations, one or more of:
configuring an electronic or mechanical device associated with the energy development operations, or
generating one or more computing models associated with the energy development operations.

11. The method of claim 1, wherein the ontology dataset comprises a library of data that connects information across multiple domains associated with the cloud data.

12. The method of claim 1, wherein the ontological structure is based on a graph data structure, the graph data structure including:
one or more nodes indicating at least one of the data elements of the cloud data or the outputs generated based on the analysis operations, and
one or more vertices indicating at least one relationship between:
the data elements of the cloud data,
the outputs generated based on the analysis operations, or
the data elements of the cloud data and the outputs generated based on the analysis operations.

13. The method of claim 1, wherein the electronic dashboard includes a search field for receiving the first user input or a second user input, the one or more display elements being generated and displayed on the electronic dashboard based on the first user input or the second user input.

14. The method of claim 1, wherein the ontology dataset is updated based on configuration data from an entity that has access to the cloud data, the entity comprising one of a user computing device or a computing device associated with an organization.

15. The method of claim 1, wherein the parsing comprises:
determining source data indicating at least one source from which one or more data elements of the cloud data originated, and
evaluating the cloud data to determine which analysis operations have been applied to the cloud data based on the source data.

16. The method of claim 1, further comprising storing the ontology dataset into a database such that the database preserves the ontological structure of the ontology dataset.

17. A system for generating an ontological dataset using cloud data for development operations, the system comprising:
a computer processor, and
memory storing instructions that are executable by the computer processor to:
receive cloud data from a plurality of sources;
generate an ontology dataset for the cloud data from the plurality of sources based on parsing the cloud data from the plurality of sources including:
evaluating the cloud data to determine which analysis operations have been applied to the cloud data;
confirming corresponding outputs generated based on the analysis operations executed on the cloud data,
generating data categories for one or more of data elements of the cloud data or the outputs generated based on the analysis operations, and
linking the data categories to generate the ontology dataset having an ontological structure that provides relationships between one or more of:
the data elements of the cloud data,
the outputs generated based on the analysis operations, or
a combination of the data elements of the cloud data and the outputs generated based on the analysis operations; and
initiate provisioning of an electronic dashboard on a display device based on a first user input, wherein:
the electronic dashboard includes one or more display elements associated with the ontology dataset, and
the one or more display elements of the electronic dashboard are activatable to load a computing resource associated with the cloud data.

18. The system of claim 17, wherein the one or more display elements of the electronic dashboard are electronically linked to the computing resource such that activating the one or more display elements loads a visual indicator of the computing resource on a graphical user interface device associated with the cloud data.

19. The system of claim 17, wherein the one or more display elements comprise at least one of:
picture data associated with the ontology dataset,
video data associated with the ontology dataset,
audio data associated with the ontology dataset, and
textual data including tabular or non-tabular data associated with the ontology dataset.

20. A computer program comprising instructions, that when executed by a computer processor of a computing device, causes the computing device to:
receive cloud data from a plurality of sources, the plurality of sources including one or more of:
workflow data native to multiple domains associated with the cloud data;
report data associated with energy development operations or energy exploration operations;
report data associated with a resource site,
report data associated with a site different from or similar to the resource site, or
simulation data associated with the resource site, the site different from or similar to the resource site, or the energy development operations or the energy exploration operations;
generate an ontology dataset for the cloud data from the plurality of sources based on parsing the cloud data from the plurality of sources including:
evaluating the cloud data to determine which analysis operations have been applied to the cloud data;
confirming corresponding outputs generated based on the analysis operations executed on the cloud data,
generating data categories for one or more of data elements of the cloud data or the outputs generated based on the analysis operations, and
linking the data categories to generate the ontology dataset having an ontological structure that provides relationships between one or more of:
the data elements of the cloud data,
the outputs generated based on the analysis operations, or
a combination of the data elements of the cloud data and the outputs generated based on the analysis operations; and
initiate provisioning of an electronic dashboard on a display device based on a first user input, wherein:
the electronic dashboard includes one or more display elements associated with the ontology dataset, and
the one or more display elements of the electronic dashboard are activatable to load a computing resource associated with the cloud data.
